(19) United States
(12) Patent Application Publication
(10) Pub. No.: US 2003/0161407 A1
(43) Pub. Date: Aug. 28, 2003

(54) Programmable and adaptive temporal filter for video encoding

(75) Inventors: John Murdock, Apalachin, NY (US); Agnes Y. Ngai, Endwell, NY (US)

Correspondence Address: Kevin P. Radigan, Esq., Heslin Rothenberg Farley & Mesiti P.C., 5 Columbia Circle, Albany, NY, 12203, US

(73) Assignee: International Business Machines Corporation, Armonk, NY

(21) Appl. No.: 10/080,963

(22) Filed: Feb. 22, 2002

(51) Int. Cl. H04N 7/12

(52) U.S. Cl. 375/240.29; 375/240.12; 375/240.2; 375/240.03

(57) ABSTRACT

A technique is provided for programmably and adaptively temporally filtering pixel values of frames of a sequence of video frames. The technique includes determining a pixel value difference between a pixel of a current frame and a corresponding pixel of a temporally previous frame; and adaptively filtering the pixel of the current frame using a selected filter coefficient. The filter coefficient is selected employing the pixel value difference. For example, multiple thresholds could be employed to differentiate between multiple filter coefficients, with the pixel value difference being employed to determine which filter coefficient is selected for the adaptive filtering. The thresholds and the filter coefficients can also be programmable. Further, the temporal filter can be integrated with a repeat field detection unit of a motion video encoder in order to conserve memory bandwidth.

### CROSS-REFERENCE TO RELATED APPLICATIONS

This application contains subject matter which is related to the subject matter of the following applications, each of which is assigned to the same assignee as this application and filed on the same day as this application. Each of the below listed applications is hereby incorporated herein by reference in its entirety:

“Programmable Vertical Filter for Video Encoding”, by Greenfield et al., U.S. Ser. No. ______ (Attorney Docket No. END920010082); and

“Programmable Horizontal Filter With Noise Reduction and Image Scaling For Video Encoding System”, by Ngai et al., U.S. Ser. No. ______ (Attorney Docket No. END920010078).

### TECHNICAL FIELD

This invention relates, in general, to compression of digital visual images, and more particularly, to a technique for programmably and adaptively temporally filtering pixel values of the frames of a sequence of motion video frames.

### BACKGROUND OF THE INVENTION

Technological advances in digital transmission networks, digital storage media, very large scale integration devices, and digital processing of video and audio signals have been converging to make the transmission and storage of digital video economical in a wide variety of applications. Because the storage and transmission of digital video signals is central to many applications, and because an uncompressed representation of a video signal requires a large amount of storage, the use of digital video compression techniques is vital to this advancing art. In this regard, several international standards for the compression of digital video signals have emerged over the past decade, with more currently under development. These standards apply to algorithms for the transmission and storage of compressed digital video in a variety of applications, including: video-telephony and teleconferencing; high quality digital television transmission on coaxial and fiberoptic networks, as well as broadcast terrestrially and other direct broadcast satellites; and in interactive multimedia products on CD-ROM, Digital Audio Tape, and Winchester disk drives.

Several of these standards involve algorithms based on a common core of compression techniques, e.g., the CCITT (Consultative Committee on International Telegraphy and Telephony) Recommendation H.120, the CCITT Recommendation H.261, and the ISO/IEC MPEG-1 and MPEG-2 standards. The MPEG algorithms have been developed by the Moving Picture Experts Group (MPEG), part of a joint technical committee of the International Standards Organization (ISO) and the International Electrotechnical Commission (IEC). The MPEG committee has been developing standards for the multiplexed, compressed representation of video and associated audio signals.

The MPEG-2 standard describes an encoding method that results in substantial bandwidth reduction by a subjective lossy compression followed by a lossless compression. The encoded, compressed digital data is subsequently decompressed and decoded in an MPEG-2 compliant decoder. The MPEG-2 standard specifies a very high compression technique that achieves compression not achievable with intraframe coding alone, while preserving the random access advantages of pure intraframe coding. The combination of frequency domain intraframe encoding and interpolative/predictive interframe encoding of the MPEG-2 standard results in a balance between intraframe encoding and interframe encoding.

The MPEG-2 standard exploits temporal redundancy for motion compensated interpolative and predictive encoding. That is, an assumption is made that “locally” the current picture can be modeled as a translation of the picture at a previous and/or future time. “Locally” implies that the amplitude and direction of the displacement are not the same everywhere in the picture.

The MPEG-2 standard further specifies predictive and interpolative interframe encoding and frequency domain intraframe encoding. It has block-based motion compensation for the reduction of temporal redundancy and discrete cosine transform based compression for the reduction of spatial redundancy. Under MPEG-2, motion compensation is achieved by predictive coding, interpolative coding, and variable length coded motion vectors. The information relative to motion is based on a 16×16 array of pixels and is transmitted with the spatial information. It is compressed with variable length codes, such as Huffman codes.

The ISO MPEG-2 compression standard specifies only the syntax of bitstream and semantics of the decoding process. The choice of coding parameters and trade-offs in performance versus complexity are left to the encoder developers.

One aspect of the encoding process is compressing a digital video image into as small a bitstream as possible while still maintaining video detail and quality. The MPEG standard places limitations on the size of the bitstream, and requires that the encoder be able to perform the encoding process. Thus, simply optimizing the bit rate to maintain desired picture quality and detail can be difficult.

Preprocessing of digital video pictures can be advantageous to the digital video encoding process. Temporal filtering is one such preprocessing technique that can be used to soften input pictures to the encoder and thereby reduce noise. This results in better compression, without loss of quality. In temporal filtering, pixel values in a current picture are weighted against corresponding pixel values in a previous picture. This weighting of pixel values is typically fixed for a given encoder. For example, an average pixel value might be created by ½ P1+½ P2, where P1 is a current pixel value, and P2 is a value of the corresponding pixel in the temporally previous frame of the sequence.

### DISCLOSURE OF THE INVENTION

Applicants recognize herein a disadvantage to a conventional temporal filter. Specifically, by fixing the filter coefficients, the conventional filter may not be optimal for different types of video sources. The present invention addresses this problem by presenting a temporal filter, integrated for example within front end logic of a digital video encoder, which uses programmable coefficients and thresholds, and which dynamically and adaptively selects a particular filter coefficient with the processing of each pixel. In another aspect, the present invention addresses optimal use of encoder memory bandwidth to allow temporal filtering with little or no impact in performance resulting from additional memory accesses.

Briefly summarized, the present invention comprises in one aspect a method of filtering pixels of a video frame of a sequence of video frames for encoding. The method includes determining a pixel value difference between a pixel of a current frame and a corresponding pixel of a temporally previous frame; and adaptively filtering the pixel of the current frame using a filter coefficient. The adaptively filtering includes employing the pixel value difference to select the filter coefficient from among multiple coefficients for use in filtering the pixel.

In a further aspect, the adaptive filtering can include employing at least one threshold and at least two filter coefficients. In one embodiment, the particular filter coefficient selected depends upon the pixel value difference relative to the at least one threshold. Further, the at least one threshold and the at least two filter coefficients could comprise programmable values, which if desired, could be modified during the encoding process.

Systems and computer program products corresponding to the above-summarized methods are also described and claimed herein.

To restate, provided herein is a technique for programmably and adaptively temporally filtering pixel values of frames of a sequence of motion video frames. The technique is programmable since the coefficients and thresholds employed in the filtering process are programmable and may be dynamically changed by a user during the encoding process. For example, one or more of the coefficients and thresholds could be changed by a user on a per picture basis if desired. The technique is adaptive in that the temporal filtering automatically selects among multiple filter coefficients for use in the filtering process. Still further, the programmable and adaptive temporal filter presented herein can be integrated with a repeat field detection function in order to take advantage of certain common hardware of the repeat field detection unit and thereby save encoder memory bandwidth.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a flow diagram of a generalized MPEG-2 compliant encoder 11, including a discrete cosine transformer 21, a quantizer 23, a variable length coder 25, an inverse quantizer 29, an inverse discrete cosine transformer 31, motion compensation 41, frame memory 42, and motion estimation 43. The data paths include the i^{th} picture input 111, difference data 112, motion vectors 113 (to motion compensation 41 and to variable length coder 25), the picture output 121, the feedback picture for motion estimation and compensation 131, and the motion compensated picture 101. This figure has the assumptions that the i^{th} picture exists in frame memory or frame store 42 and that the i+1^{th} is being encoded with motion estimation.

FIG. 2 illustrates the I, P, and B pictures, examples of their display and transmission orders, and forward, and backward motion prediction.

FIG. 3 illustrates the search from the motion estimation block in the current frame or picture to the best matching block in a subsequent or previous frame or picture. Elements 211 and 211′ represent the same location in both pictures.

FIG. 4 illustrates the movement of blocks in accordance with the motion vectors from their position in a previous picture to a new picture, and the previous picture's blocks adjusted after using motion vectors.

FIG. 5 illustrates one embodiment of a temporal filter integrated with repeat field detection logic of a video encoder, in accordance with an aspect of the present invention.

FIG. 6 depicts in greater detail one embodiment of the integrated repeat field detection logic and temporal filter of FIG. 5, in accordance with an aspect of the present invention.

FIG. 7 illustrates one embodiment of programmable, adaptive temporal filtering logic in accordance with an aspect of the present invention.

FIG. 8 illustrates one embodiment of a process for adaptively temporally filtering pixel values in accordance with an aspect of the present invention.

### BEST MODE FOR CARRYING OUT THE INVENTION

The invention relates, for example, to MPEG compliant encoders and encoding processes such as described in “Information Technology-Generic coding of moving pictures and associated audio information: Video,” Recommendation ITU-T H.262, ISO/IEC 13818-2, International Standard, 1996. The encoding functions performed by the encoder include data input, spatial compression, motion estimation, macroblock type generation, data reconstruction, entropy coding, and data output. Spatial compression includes discrete cosine transformation (DCT), quantization, and entropy encoding. Temporal compression includes intensive reconstructive processing, such as inverse discrete cosine transformation, inverse quantization, and motion compensation. Motion estimation and compensation are used for temporal compression functions. Spatial and temporal compression are repetitive functions with high computational requirements.

More particularly the invention relates, for example, to a process for performing spatial and temporal compression including discrete cosine transformation, quantization, entropy encoding, motion estimation, motion compensation, and prediction, and even more particularly to a system for accomplishing spatial and temporal compression.

The first compression step is the elimination of spatial redundancy, for example, the elimination of spatial redundancy in an “I” frame picture. Spatial redundancy is the redundancy within a picture. The MPEG-2 Standard uses a block based method of reducing spatial redundancy. The method of choice is the discrete cosine transformation, and discrete cosine transform coding of the picture. Discrete cosine transform coding is combined with weighted scalar quantization and run length coding to achieve a desirable compression.

The discrete cosine transformation is an orthogonal transformation. Orthogonal transformations, because they have a frequency domain interpretation, are filter bank oriented. The discrete cosine transformation is also localized. That is, the encoding process samples on an 8×8 spatial window which is sufficient to compute 64 transform coefficients or sub-bands.

Another advantage of the discrete cosine transformation is that fast encoding and decoding algorithms are available. Additionally, the sub-band decomposition of the discrete cosine transformation is sufficiently well behaved to allow effective use of psychovisual criteria.

After transformation, many of the frequency coefficients are zero, especially the coefficients for high spatial frequencies. These coefficients are organized into a zig-zag or alternate-scanned pattern, and converted into run-amplitude (run-level) pairs. Each pair indicates the number of zero coefficients and the amplitude of the non-zero coefficient. This is coded in a variable length code.

Motion compensation is used to reduce or even eliminate redundancy between pictures. Motion compensation exploits temporal redundancy by dividing the current picture into blocks, for example, macroblocks, and then searching in previously transmitted pictures for a nearby block with similar content. Only the difference between the current block pels and the predicted block pels extracted from the reference picture is actually compressed for transmission and thereafter transmitted.

One method of motion compensation and prediction is to record the luminance and chrominance, i.e., intensity and color, of every pixel in an “I” picture, then record changes of luminance and chrominance, i.e., intensity and color for every specific pixel in the subsequent picture. However, this is uneconomical in transmission medium bandwidth, memory, processor capacity, and processing time because objects move between pictures, that is, pixel contents move from one location in one picture to a different location in a subsequent picture. A more advanced idea is to use a previous or subsequent picture to predict where a block of pixels will be in a subsequent or previous picture or pictures, for example, with motion vectors, and to write the result as “predicted pictures” or “P” pictures. More particularly, this involves making a best estimate or prediction of where the pixels or macroblocks of pixels of the i^{th} picture will be in the i−1^{th} or i+1^{th} picture. It is one step further to use both subsequent and previous pictures to predict where a block of pixels will be in an intermediate or “B” picture.

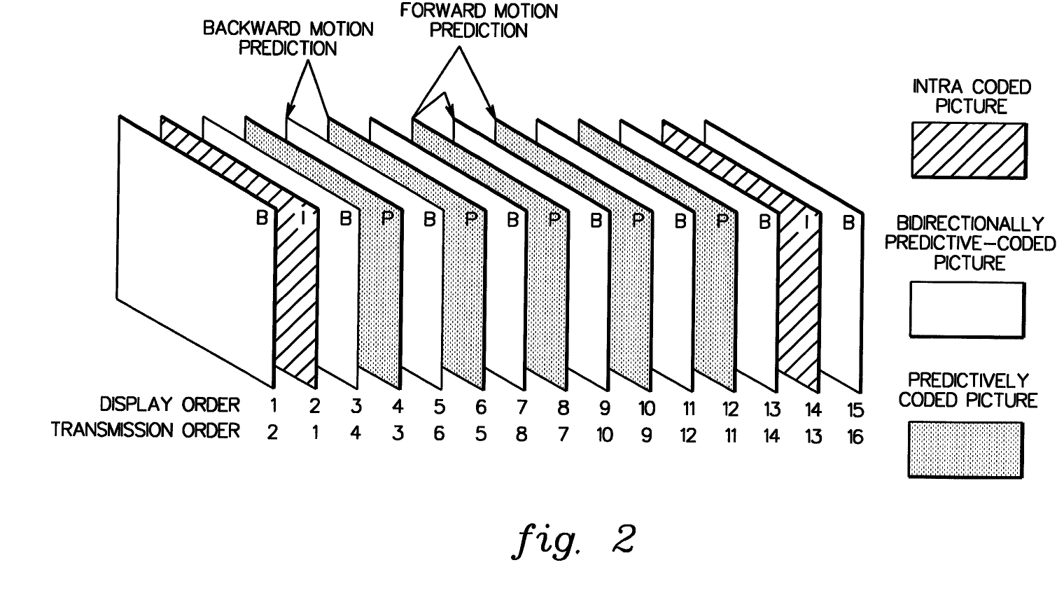

To be noted is that the picture encoding order and the picture transmission order do not necessarily match the picture display order. See FIG. 2. For I-P-B systems the input picture transmission order is different from the encoding order, and the input pictures must be temporarily stored until used for encoding. A buffer stores this input until it is used.

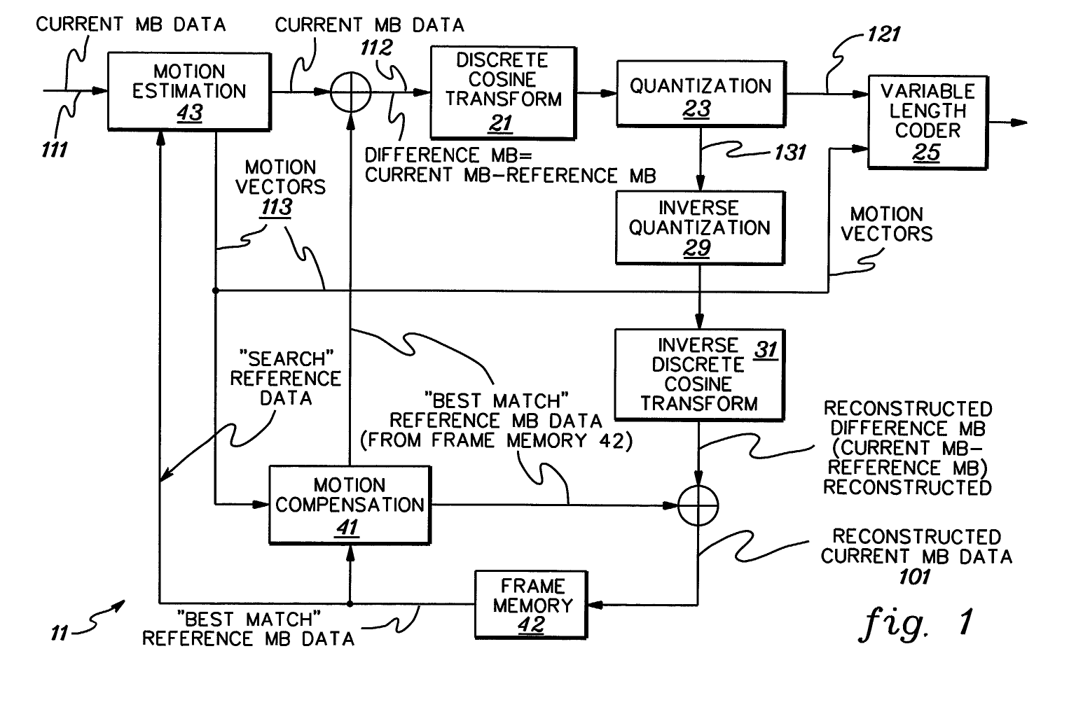

For purposes of illustration, a generalized flowchart of MPEG compliant encoding is shown in FIG. 1. In the flowchart, the images of the i^{th} picture and the i+1^{th} picture are processed to generate motion vectors. The motion vectors predict where a macroblock of pixels will be in a prior and/or subsequent picture. The use of the motion vectors is a key aspect of temporal compression in the MPEG standard. As shown in FIG. 1 the motion vectors, once generated, are used for the translation of the macroblocks of pixels, from the i^{th} picture to the i+1^{th} picture.

As shown in FIG. 1, in the encoding process, the images of the i^{th} picture and the i+1^{th} picture are processed in the encoder 11 to generate motion vectors which are the form in which, for example, the i+1^{th} and subsequent pictures are encoded and transmitted. An input image 111 of a subsequent picture goes to the motion estimation unit 43 of the encoder. Motion vectors 113 are formed as the output of the motion estimation unit 43. These vectors are used by the motion compensation unit 41 to retrieve macroblock data from previous and/or future pictures, referred to as “reference” data, for output by this unit. One output of the motion compensation unit 41 is negatively summed with the output from the motion estimation unit 43 and goes to the input of the discrete cosine transformer 21. The output of the discrete cosine transformer 21 is quantized in a quantizer 23. The output of the quantizer 23 is split into two outputs, 121 and 131; one output 121 goes to a downstream element 25 for further compression and processing before transmission, such as to a run length encoder; the other output 131 goes through reconstruction of the encoded macroblock of pixels for storage in frame memory 42. In the encoder shown for purposes of illustration, this second output 131 goes through an inverse quantization 29 and an inverse discrete cosine transform 31 to return a lossy version of the difference macroblock. This data is summed with the output of the motion compensation unit 41 and returns a lossy version of the original picture to the frame memory 42.

As shown in FIG. 2, there are three types of pictures. There are “Intra pictures” or “I” pictures which are encoded and transmitted whole, and do not require motion vectors to be defined. These “I” pictures serve as a reference image for motion estimation. There are “Predicted pictures” or “P” pictures which are formed by motion vectors from a previous picture and can serve as a reference image for motion estimation for further pictures. Finally, there are “Bidirectional pictures” or “B” pictures which are formed using motion vectors from two other pictures, one past and one future, and can not serve as a reference image for motion estimation. Motion vectors are generated from “I” and “P” pictures, and are used to form “P” and “B” pictures.

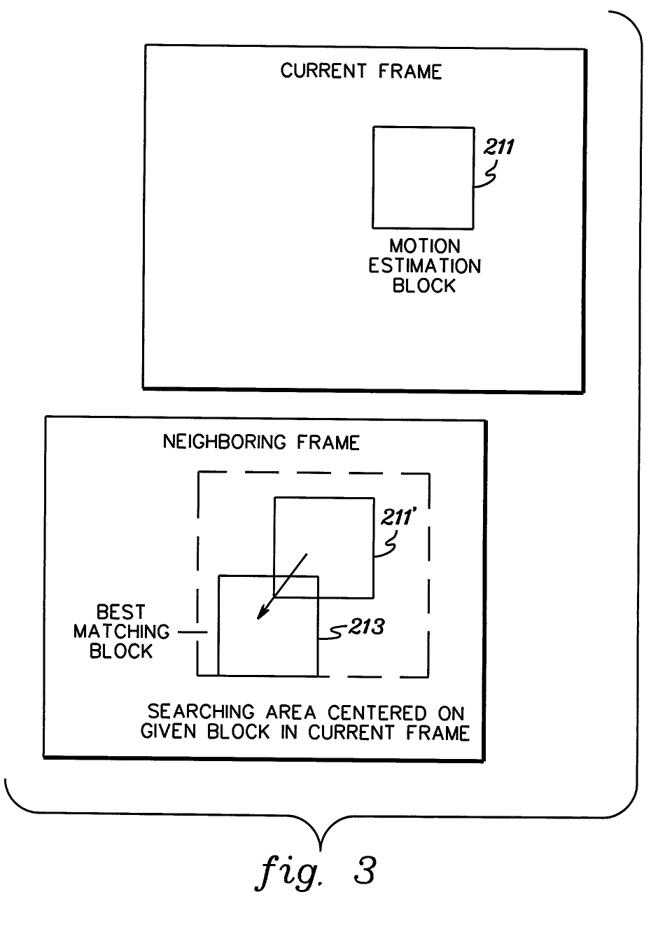

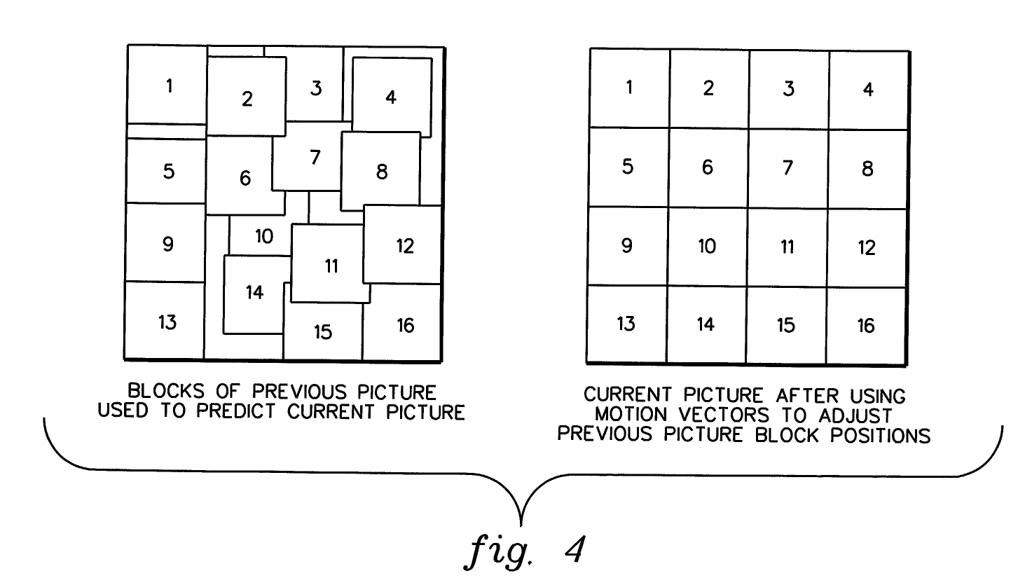

One method by which motion estimation is carried out, shown in FIG. 3, is by a search from a macroblock 211 of an i^{th} picture throughout a region of the next picture to find the best match macroblock 213. Translating the macroblocks in this way yields a pattern of macroblocks for the i+1^{th} picture, as shown in FIG. 4. In this way the i^{th} picture is changed a small amount, e.g., by motion vectors and difference data, to generate the i+1^{th} picture. What is encoded are the motion vectors and difference data, and not the i+1^{th} picture itself. Motion vectors translate position of an image from picture to picture, while difference data carries changes in chrominance, luminance, and saturation, that is, changes in shading and illumination.

Returning to FIG. 3, processing searches for a good match by starting from the same location in the i^{th} picture as in the i+1^{th} picture. A search window is created in the i^{th} picture. We search for a best match within this search window. Once found, the best match motion vectors for the macroblock are coded. The coding of the best match macroblock includes a motion vector, that is, how many pixels in the y direction and how many pixels in the x direction is the best match displaced in the next picture. Also encoded is difference data, also referred to as the “prediction error”, which is the difference in chrominance and luminance between the current macroblock and the best match reference macroblock.

The operational functions of an MPEG-2 encoder are discussed in further detail in U.S. Pat. No. 6,118,823 by Carr et al., entitled “Control Scheme For Shared-Use Dual-Port Predicted Error Array,” which is hereby incorporated herein by reference in its entirety.

As noted above, temporal filtering softens a picture (and reduces noise) by changing the value of a given pixel in the current picture to a new, filtered value which is a function of the current value (P1) and the pixel value (P2) at the same x,y pixel location in a temporally previous picture. A large difference in these two pixel values can be lessened through a temporal filter. A softened picture is one whose pixel differences have been smoothed by such a function, allowing the encoding process to proceed easier and the output to be more visually appealing. Noise manifests itself as random changes in pixel values and therefore can also be reduced through the same filtering technique.

Presented hereinbelow are certain enhanced temporal filter implementations in accordance with aspects of the present invention.

An adaptive, programmable temporal filtering solution in accordance with the present invention begins by calculating the difference between P1 and P2 (i.e., P1−P2). The solution then determines a filtered value to replace P1 by equation (1):

filtered value=P1(f)+P2(1−f) (1)

wherein:

0≦f≦1

The value f is an adaptive and programmable value as used herein, which can be determined by a user or by microcode. It can be changed dynamically as a function of information obtained from certain calculations. For example, the value of f can be decreased if the difference between the current pixel value P1 and the corresponding pixel value of a previous picture P2 is large.

Programmable difference thresholds can also be used to create difference bands where different values of f can selected for use. For instance, if two thresholds (th1 and th2) are employed, then three bands are created where three different f values (f1, f2 and f3) can be used. A first band would be for all difference values (P1−P2) that fall between 0 and th1. If the difference falls within this range, f1 is used for the filtered value calculation in equation (1). A second band is between th1 and th2, where f2 would be used, and a third band that uses f3 comprises the range of th2 to some maximum value. All values of th1, th2, f1, f2, f3, etc. are programmable, for example, by the user on a picture boundary. With two sets of registers to hold these values at the user interface, one set could be used to process the current input picture while the user could prepare and change the second set, which could be automatically used in the following input picture if desired.

### EXAMPLE

th1=7

th2=15

f1=0.75

f2=0.50

f3=0.25

If P1=20 and P2=16:

P1−P2=4, f=f1=0.75 since 4<th1

Therefore, the new pixel value=0.75(20)+0.25(16)=15+4=19.

If P1=20 and P2=12:

P1−P2=8, f=f2=0.50 since th1<8<th2

Therefore, the new pixel value=0.50(20)+0.50(16)=10+8=18.

If P1=20 and P2=4:

P1−P2=16, f=f3=0.25 since 16>th2

Therefore, the new pixel value=0.25(20)+0.75(4)=5+3=8.

In order to calculate the difference between pixel values of successive pictures, pixel data from a just previous picture must be fetched from memory by the encoder system as the current picture is being fed into the encoder. Higher memory bandwidth would thus typically be required to support temporal filtering in an encoder system.

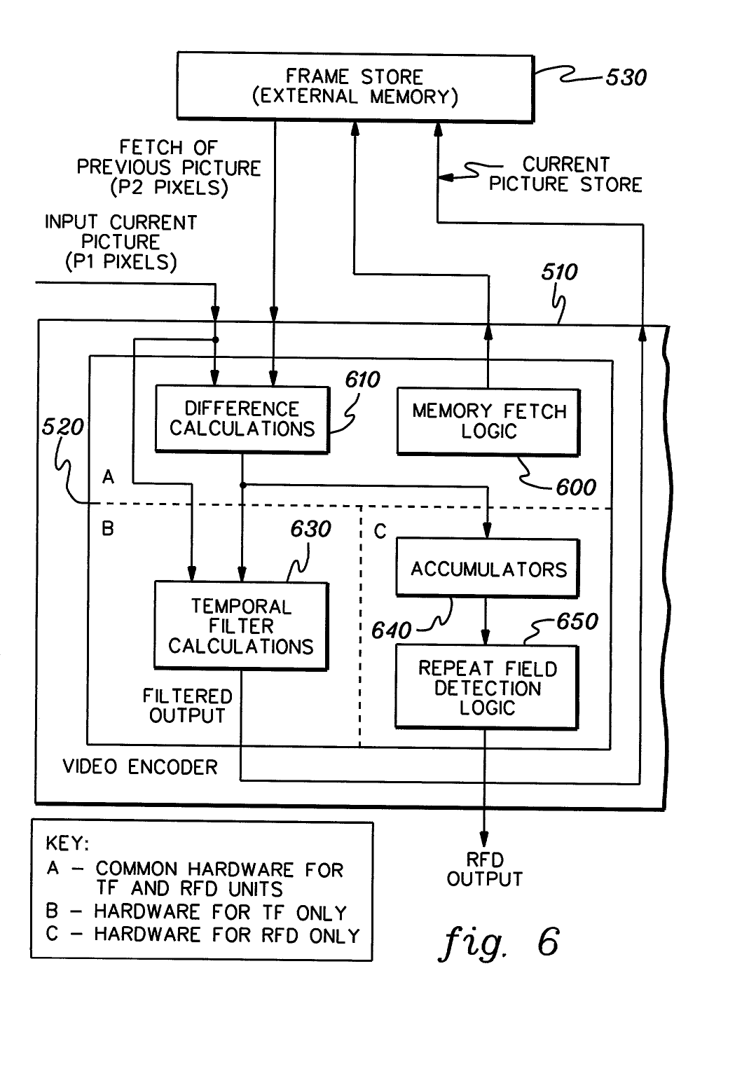

A common function within digital video encoders is the inverse 3:2 pulldown function. This function detects repeat fields and discards them so that repeat fields are not encoded, but instead flagged in the encoded stream for a decoder to subsequently recreate the original video sequence. In order to determine a repeat field, the encoder often evaluates the cumulative sum of all the pixel value differences between the current picture and the previous picture. Therefore, an existing inverse 3:2 pulldown function is not only fetching the just previous picture's pixel data, which is needed by the temporal filter, but it is also performing the P1−P2 calculation. Thus, by integrating the temporal filter into the inverse 3:2 pulldown function (as proposed herein), there is no longer a need for additional memory bandwidth, and hardware area is reduced by using common logic circuits (i.e., memory fetch logic, difference calculation logic, etc.) as described further below with reference to FIG. 6.

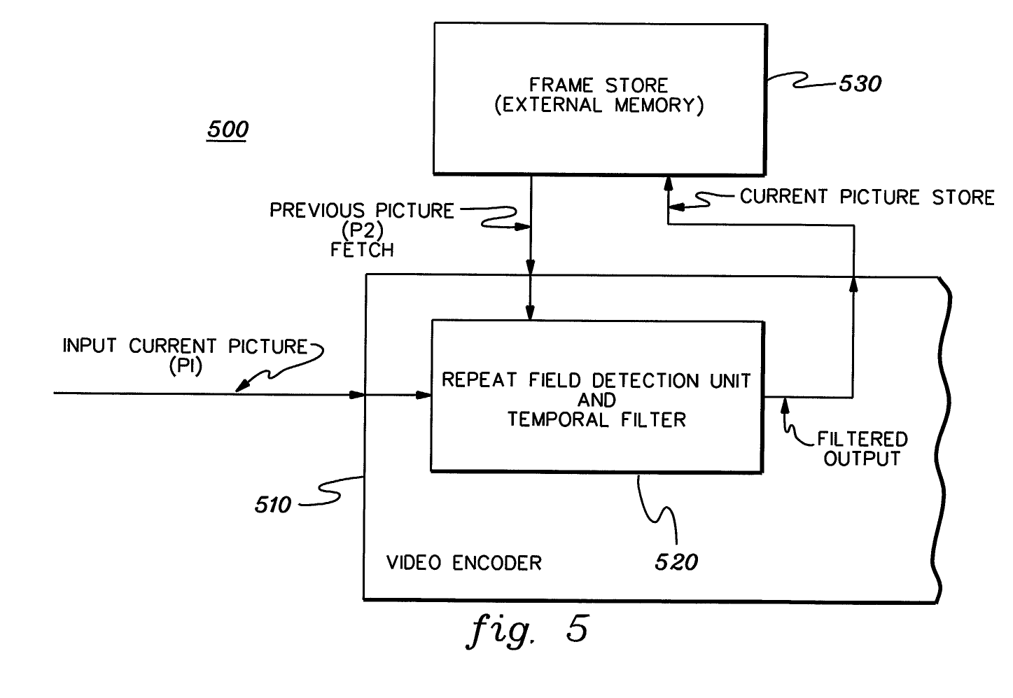

The encoding system, generally denoted 500, in FIG. 5 depicts one encoder implementation employing a temporal filter in accordance with the present invention. System 500 includes a video encoder 510 having an integrated repeat field detection unit and temporal filter 520. The video encoder 510 stores data to and retrieves data from an external frame store 530. The function of a conventional repeat field detection unit is described, for example, in U.S. Pat. No. 5,606,373, which is hereby incorporated herein by reference.

When in use, the temporal filter receives uncompressed, current pixel values (P1) and compares those values to the pixel values of the temporally prior frame (P2), which are fetched from memory 530 by the repeat field detection unit. The temporal filter employs the pixel value difference (P1−P2) as discussed above in adaptively filtering the uncompressed pixel values P1. The filtered output of the current picture is forwarded to the frame store 530 in place of the uncompressed pixel data.

FIG. 6 depicts in greater detail an integrated embodiment of a repeat field detection unit and temporal filter 520 in accordance with an aspect of the present invention. This integrated logic 520 again resides in this embodiment within a video encoder 510. However, those skilled in the art should note that the integrated repeat detection unit and temporal filter (or alternatively only the temporal filter), could comprise preprocessing logic disposed outside of the video encoder and still provide the programmable, adaptive temporal filtering disclosed herein.

The integrated logic 520 includes (in this embodiment) three logic blocks, labeled A, B & C. Logic block A, which includes memory fetch logic 600 and difference calculation logic 610, comprises common hardware logic for both the temporal filter (TF) and the repeat field detection (RFD) units. Logic block B comprises a temporal filter calculation logic 630, which is hardware dedicated to the temporal filter operation, while logic block C includes an accumulator 640 and repeat field detection logic 650, which is hardware specific to the RFD unit.

Operationally, memory fetch logic 600 fetches from frame store 530 pixels from the temporally prior picture (P2) for input to difference calculation logic 610. Logic 610 also receives as input the current picture pixels (P1) and determines the difference between a current picture pixel (P1) and the prior corresponding picture pixel (P2) (i.e., P1−P2). This difference is output to both the temporal filter calculation 630 and to accumulators 640.

Also input to temporal filter calculation 630 is the uncompressed current picture pixel data (P1). The temporal filter calculations 630 use the difference calculation and the current uncompressed data to temporally filter the uncompressed data as discussed above. A filtered output is provided by the filter calculations, which comprises the current picture store return to frame store 530. The current picture store is the data which will actually be compressed by the video encoder, and is also the data which will become the previous picture information for the next current picture in the stream of motion video frames.

The difference calculation input to accumulators 640 is employed by the accumulators in the repeat field detection logic 650 to determine a repeat field detection output in accordance with techniques known in the art, such as described in the above-incorporated U.S. Pat. No. 5,606,373.

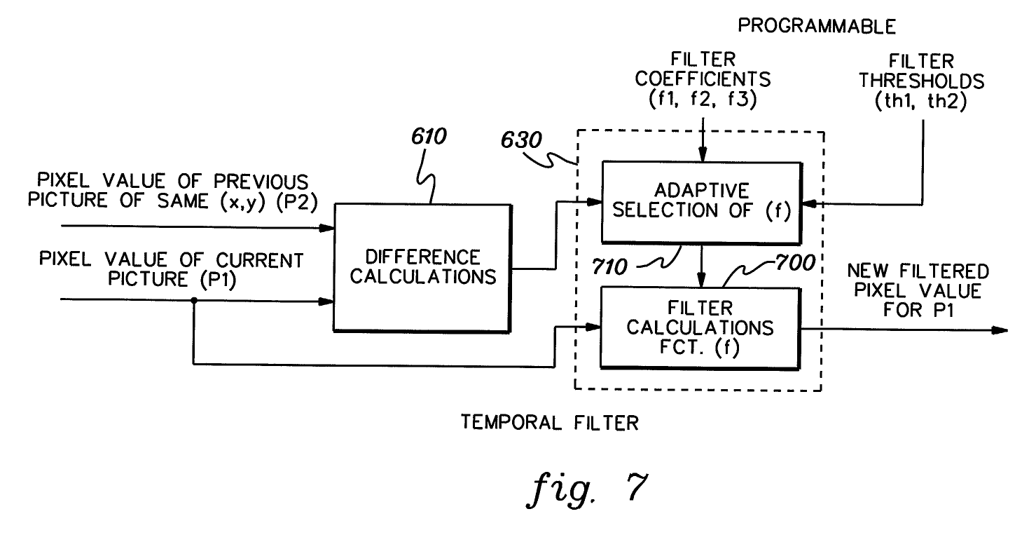

FIG. 7 depicts in greater detail logic for programmable, adaptive temporal filtering of pixels in accordance with an aspect of the present invention. This logic again includes, in one embodiment, difference calculation logic 610, which may be shared with or comprise an existing difference calculation logic block of a repeat field detection unit. Difference calculations logic 610 receives as input the current pixel values (P1) and the corresponding pixel values of the previous picture at the same x,y locations (P2) in order to determine the pixel value difference P1−P2. This difference is fed into an adaptive selection logic block 710 (of temporal filter calculations 630), which selects a filter coefficient (f) for use in the filter calculations 700.

As noted above, in one embodiment, the adaptive selection of filter coefficients can be facilitated by the use of filter thresholds, such as the th1 & th2 thresholds discussed. The use of two filter thresholds allows for the adaptive selection of one of three filter coefficients (f1, f2, f3) as explained above. Further, in one embodiment, both the filter thresholds and the filter coefficients can be programmable. For example, these values could be dynamically reprogrammable during the encoding of a stream of video frames. In one embodiment, this could be accomplished through the use of dual sets of registers, along with a toggle signal to instruct the adaptive selection logic to employ thresholds and filter coefficients located in a particular set of the registers. Output from filter calculation 700 is a new, filtered pixel value for P1. Depending on the values of f selected, it is possible that the filtered pixel value for P1, in certain circumstances, could comprise the actual uncompressed pixel value P1 as received into the temporal filter. In most cases, however, the output from filter calculations 700 will be a filtered pixel value for each pixel of a video frame, i.e., assuming that the filter is enabled.

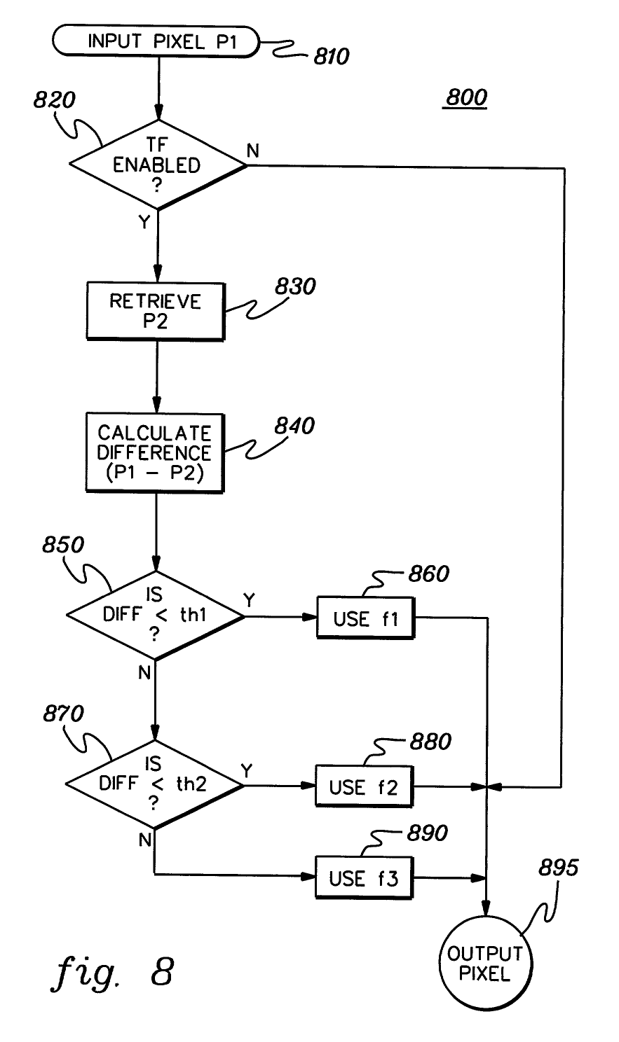

FIG. 8 depicts one embodiment of temporal filter processing in accordance with a particular filter algorithm such as described herein. Processing 800 begins with input of a pixel value P1 810, and initially inquires whether the temporal filtering is enabled 820. If “no”, then the received pixel value is the outputted pixel 895, which as noted, is forwarded to the external frame store for subsequent retrieval for encoding.

Assuming that temporal filtering is enabled, then the corresponding pixel value P2 of the temporally previous frame is retrieved from frame store 830, and the difference between P1 and P2 is calculated 840. This difference is employed in a temporal filter such as described herein in order to adaptively select a particular filter coefficient. For example, by using two thresholds, three filter coefficients can be provided for possible selection.

In the processing of FIG. 8, a determination is next made whether the difference calculation is less than a first threshold (th1) 850, and if so, then a first filter coefficient (f1) 860 is employed in calculating the temporally filtered pixel value for output 895. If the P1−P2 difference is greater than the first threshold, then processing determines whether the value is less than the second threshold 870. If so, then a second filter coefficient f2 is employed 880 in performing the temporal filtering, for example, in accordance with equation (1). Otherwise, a third filter coefficient f3 890 is employed. In either case, the filtered pixel value for P1 is output 895 to a frame-store for subsequent retrieval.

Those skilled in the art will note from the above discussion that a programmable, adaptive temporal filter is provided herein, which in one embodiment, may be integrated with an existing repeat field detection encoder function in order to save on memory bandwidth.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of filtering pixels of a video frame of a sequence of video frames, said method comprising:
determining a pixel value difference between a pixel of a current frame and a corresponding pixel of a temporally previous frame; and
adaptively filtering said pixel of said current frame using a filter coefficient, said adaptively filtering comprising employing said pixel value difference to select said filter coefficient for use in filtering said pixel.

2. The method of claim 1, wherein the adaptively filtering comprises employing at least one threshold and at least two filter coefficients, wherein said filter coefficient is automatically selected by said adaptively filtering from-said at least two filter coefficients depending upon said pixel value difference relative to said at least one threshold.

3. The method of claim 2, wherein said adaptively filtering further comprises programmably, adaptively filtering said pixel of said current frame using said filter coefficients, and wherein at least one of said at least one threshold and said at least two filter coefficients can be programmably varied.

4. The method of claim 2, wherein the at least one threshold comprises a first threshold and a second threshold, and wherein the at least two filter coefficients comprises a first filter coefficient, a second filter coefficient and a third filter coefficient, wherein said first filter coefficient is selected by the adaptively filtering if the pixel value difference is below said first threshold, said second filter coefficient is selected by the adaptively filtering if the pixel value difference is between said first threshold and said second threshold, and said third filter coefficient is selected by the adaptively filtering if the pixel value difference is greater than said second threshold.

5. The method of claim 1, wherein said adaptively filtering further comprises outputting a filtered pixel value (FPV), wherein said FPV is determined by:
FPV=P1(f)+P2(1−f)
wherein:
P1=pixel value of a current pixel
P2=pixel value of the corresponding (x,y) pixel in the temporally previous frame
f=selected filter coefficient.

6. The method of claim 1, further comprising implementing said method within temporal filter logic integrated with a repeat field detection unit of a video encoder.

7. The method of claim 6, wherein said implementing includes integrating said determining of the pixel value difference with said repeat field detection unit of said video encoder, said integrating comprising employing difference calculation logic within the repeat field detection unit to determine said pixel value difference.

8. A system for filtering pixels of a video frame of a sequence of video frames, said system comprising:
a temporal filter, said temporal filter comprising:
means for determining a pixel value difference between a pixel of a current frame and a corresponding pixel of a temporally previous frame; and
means for adaptively filtering said pixel of said current frame using a filter coefficient, said means for adaptively filtering comprising means for employing said pixel value difference to select said filter coefficient for use in filtering said pixel.

9. The system of claim 8, wherein said means for adaptively filtering comprises means for employing at least one threshold and at least two filter coefficients, wherein said filter coefficient is automatically selected by said means for adaptively filtering from said at least two filter coefficients depending upon the pixel value difference relative to the at least one threshold.

10. The system of claim 9, wherein said means for adaptively filtering further comprises means for programmably, adaptively filtering said pixel of said current frame using said filter coefficients, and wherein at least one of said at least one threshold and said at least two filter coefficients can be programmably varied.

11. The system of claim 9, wherein the at least one threshold comprises a first threshold and a second threshold, and wherein said at least two filter coefficients comprise a first filter coefficient, a second filter coefficient, and a third filter coefficient, wherein said first filter coefficient is selected by said means for adaptively filtering if the pixel value difference is below said first threshold, said second filter coefficient is selected by the means for adaptively filtering if the pixel value difference is between said first threshold and said second threshold, and said third filter coefficient is selected by the adaptively filtering if the pixel value difference is greater than said second threshold.

12. The system of claim 8, wherein said adaptively filtering further comprises means for outputting a filtered pixel value (FPV), wherein said FPV is determined by:
FPV=P1(f)+P2(1−f)
wherein:
P1=pixel value of a current pixel
P2=pixel value of the corresponding (x,y) pixel in the temporally previous frame
f=selected filter coefficient.

13. The system of claim 8, further comprising a repeat field detection unit for a video encoder, and wherein said temporal filter is integrated with said repeat field detection unit.

14. The system of claim 13, wherein said means for determining of said temporal filter comprises memory fetch logic and difference calculation logic within the repeat field detection unit, said memory fetch logic comprising means for fetching said corresponding pixel of a temporally previous frame, and said difference calculation logic comprising means for calculating said pixel value difference.

15. At least one program storage device readable by a machine, tangibly embodying at least one program of instructions executable by the machine to perform a method of filtering pixels of a video frame of a sequence of video frames, said method comprising:
determining a pixel value difference between a pixel of a current frame and a corresponding pixel of a temporally previous frame; and
adaptively filtering said pixel of said current frame using a filter coefficient, said adaptively filtering comprising employing said pixel value difference to select said filter coefficient for use in filtering said pixel.

16. The at least one program storage device of claim 15, wherein said adaptively filtering comprises employing at least one threshold and at least two filter coefficients, wherein said filter coefficient is automatically selected by said adaptively filtering from said at least two filter coefficients depending upon the pixel value difference relative to the at least one threshold.

17. The at least one program storage device of claim 16, wherein said adaptively filtering further comprises programmably, adaptively filtering said pixel of said current frame using said filter coefficients, and wherein at least one of said at least one threshold and said at least two filter coefficients can be programmably varied.

18. The at least one program storage device of claim 16, wherein the at least one threshold comprises a first threshold and a second threshold, and wherein the at least two filter coefficients comprises a first filter coefficient, a second filter coefficient and a third filter coefficient, wherein said first filter coefficient is selected by the adaptively filtering if the pixel value difference is below said first threshold, said second filter coefficient is selected by the adaptively filtering if the pixel value difference is between said first threshold and said second threshold, and said third filter coefficient is selected by the adaptively filtering if the pixel value difference is greater than said second threshold.

19. The at least one program storage device of claim 15, wherein said adaptively filtering further comprises outputting a filtered pixel value (FPV), wherein said FPV is determined by:
FPV=P1(f)+P2(1−f)
wherein:
P1=pixel value of a current pixel
P2=pixel value of the corresponding (x,y) pixel in the temporally previous frame
f=selected filter coefficient.

20. The at least one program storage device of claim 15, further comprising automatically repeating said determining and said adaptively filtering for pixels of multiple video frames of the sequence of video frames.
